(19) United States
(12) Patent Application Publication
(10) Pub. No.: US 2010/0204760 A1
(43) Pub. Date: Aug. 12, 2010

(54) Personal Steam Room and Sauna

(76) Inventor: Ryan Lawliss, Palm Desert, CA (US)

Correspondence Address: Larry E Severin, Esq, 3581 Teaberry Circle, Seal Beach, CA, 90740, US

(21) Appl. No.: 12/705,417

(22) Filed: Feb. 12, 2010

Related U.S. Application Data
(60) Provisional application No. 61/207,347, filed on Feb. 12, 2009.

(51) Int. Cl. A61H 33/06

(52) U.S. Cl. 607/83; 607/81

(57) ABSTRACT

A personal steam room and sauna includes: a reclining surface for the user; a source that produces therapy; and an enclosure adapted to enclose the reclining surface and the user; wherein the enclosure transitions between an open position, where the reclining surface is exposed for access by the user, and a closed position, where the reclining surface and the user are enclosed by the enclosure and the enclosure partially retains the therapy, thereby delivering the therapy to the user. The therapy may be water vapor, steam, heat, or aromatic oil, which may rise through the reclining surface to the user. The enclosure either slides forward and tilts upward, or tilts to the side to allow the user to get in and out of the device.

### RELATED APPLICATIONS

This application claims the benefit of the filing date of U.S. Patent Application No. 61/207,347, filed Feb. 12, 2009, which is incorporated herein by reference in its entirety.

### BACKGROUND OF THE INVENTION

The present invention generally relates to saunas and more specifically to a personal steam room and sauna.

It would be desirable to have a sit-down, laid back pod/lounge chair steam room/sauna, fully covered, where steam rises from the bottom through the chair, with a slide-forward and tilt-up cover/top.

### SUMMARY OF THE INVENTION

In one aspect of the present invention, a device for delivering a therapy to a user includes: a reclining surface for the user; a source that produces therapy; and an enclosure adapted to enclose the reclining surface and the user; wherein the enclosure transitions between an open position, where the reclining surface is exposed for access by the user, and a closed position, where the reclining surface and the user are enclosed by the enclosure and the enclosure partially retains the therapy, thereby delivering the therapy to the user.

In another aspect of the present invention, a personal sauna includes: a lounge chair; a therapy generator; and an enclosure that keeps in the therapy; wherein the enclosure opens for access, and closes to enclosure the chair.

In yet another aspect of the present invention, a method of delivering a therapy to a user includes: reclining the user on a reclining surface; enclosing the user and the reclining surface with a clear enclosure; and generating a therapy, selected from the group consisting of water vapor, steam, heat, and aromatic oil; wherein the enclosure partially retains the therapy, thereby delivering the therapy to the user.

### BRIEF DESCRIPTION OF THE DRAWINGS

FIG. 1 depicts a side view of an embodiment of the present invention;

FIGS. 2A, 2B, 2C depict side view of embodiments of the present invention being opened;

FIG. 2D depicts an end view of an embodiment of the present invention being opened;

FIG. 3 depicts a side view of the embodiment of FIG. 1;

FIG. 4 depicts an end view of the embodiment of FIG. 1; and

FIG. 5 depicts a perspective view of the embodiment of FIG. 1.

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

An embodiment of the present invention generally provides a covered, portable pod and lounge chair for a steam room with steam generator or infrared heater or both, MPEG-1 Audio Layer 3 (MP3) player, speakers, aromatherapy, and oxygen fan.

An embodiment may include a steam room or sauna that provides a comfortable, fully enclosed system which is adapted for aromatherapy. A therapy may include steam or warm water vapor that rises from the bottom of the chair, through the slats to hit areas of the body. A therapy may include heat provided by electric or infrared heaters. An enclosure or cover may be made out of glass or plastic or other clear, rigid material that slides forward, toward the user's feet, and tilts upward to make it easy to get in and out of the pod or chair. An embodiment may include aromatherapy, music player, kiosk controls, and oxygen fan with filter, adjustable pillow, wheels and handle attached for easy moving. Embodiments may include vibration or massage pads. Embodiments may be fully enclosed, and may include a removable canvas or other cover.

An embodiment of a steam room and sauna may include a device that allows a human person lie down in a pod/lounge chair and receive steam or heat from the pod/chair. Treatments with the device could assist with detoxification and other health improvement of the user, through sweating and breathing in oils. Embodiments may be used for therapeutic or everyday health.

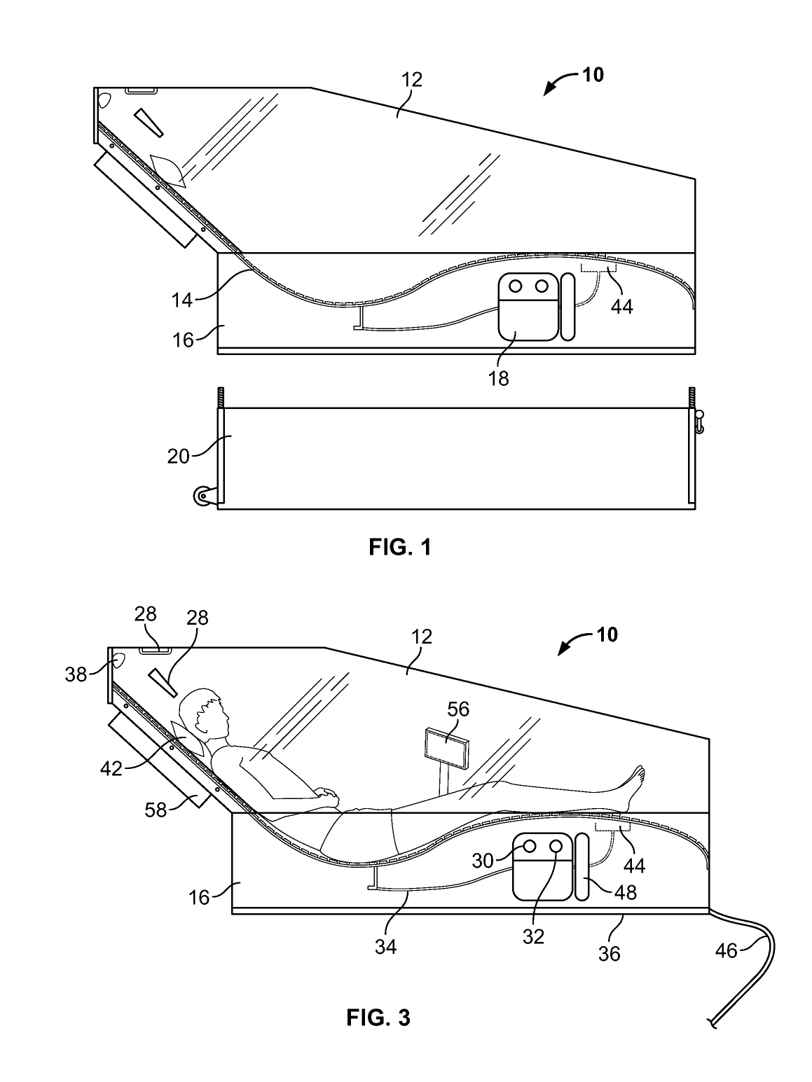

As depicted in FIG. 1, an embodiment is a device 10 may include a cover 12, which is a glass, plastic or acryl enclosure that partially retains and keeps in heat, steam, or aroma. A plastic or wood lounge chair 14 or other reclining surface may be a contour chair made from plastic, woods, or other material that do not get hot from heat. Base box frame 16 may be a box frame housing that supports the human and all components. Base box frame 16 may also house all the internal components. A steam generator 18 may have hoses, and may provide and generate steam. An optional extra rising box frame 20 may raise the whole device to make it easier for a human, such as a disabled user, to get in and out of the device.

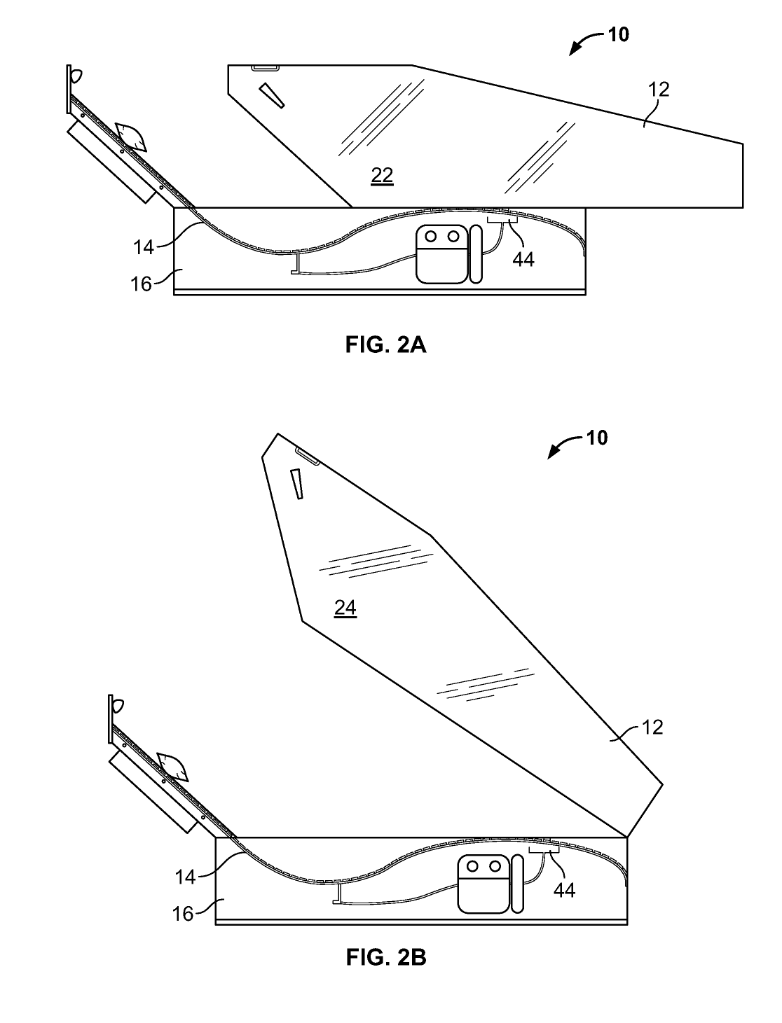

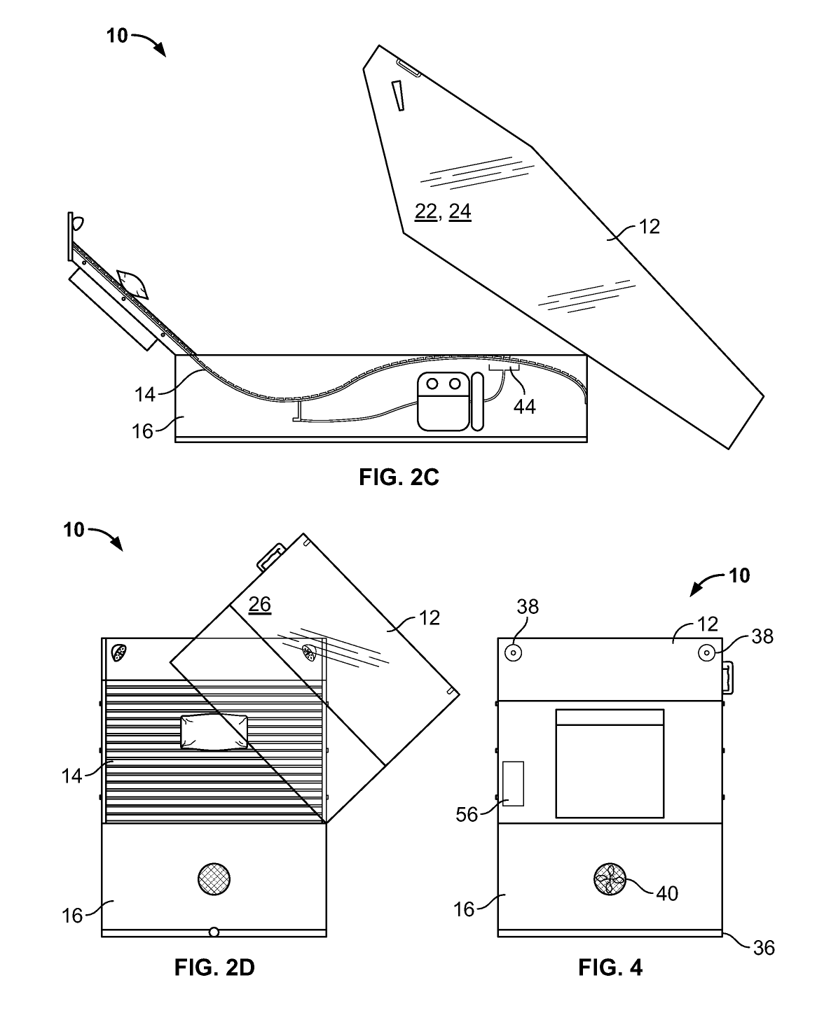

As depicted in the embodiment of FIG. 2A, the cover 12 may slide forward 22 on tracks, rails or rollers to open the cover 12. As depicted in the embodiment of FIG. 2B, the cover 12 may tilt up 24 with hydraulic one or more arms to open the cover 12. As depicted in the embodiment of FIG. 2C, the cover 12 may both slide forward and tilt upward 22, 24 to open the cover 12. This motion makes sure that the cover is fully out of the way for when a human enters or exits the device 10. As depicted in the embodiment of FIG. 2D, the cover 12 may tilt to the side 26 with hydraulic arms.

As depicted in the embodiment of FIG. 3, a device 10 may include handles 20, which are used to grip the cover 12 to make it easier for the human to open and close the device 10. A steam generator timer 30 may be an electronic function in a kiosk. The timer 30 may provide a time limit for how long the steam generator 18 is producing steam. The timer 30 may also provide a time limit for an infrared heater and/or electric heater. A steam generator hi/low control 32 may be an electronic function in a kiosk. Hi/low control 32 controls how much power is given to the steam generator 18. Steam hoses 34 may run from the steam generator 18 to the bottom of the pod/lounge chair 14. The hoses have small holes for releasing steam to multiple areas under the pod/chair 14. A two-step adjustable pillow 42 may adjust up and down for different size humans and provides support for the neck and head. Aromatherapy dish 44 may provide a place for oils to be evaporated. An electrical 110 volt cord 46 may provide power for the device 10, and may include a ground fault interrupter (GFI). A water reservoir 48 may provides water for the steam generator 18. An infrared heater 58 or electric heater may provide heat for a sauna effect that results in sweating.

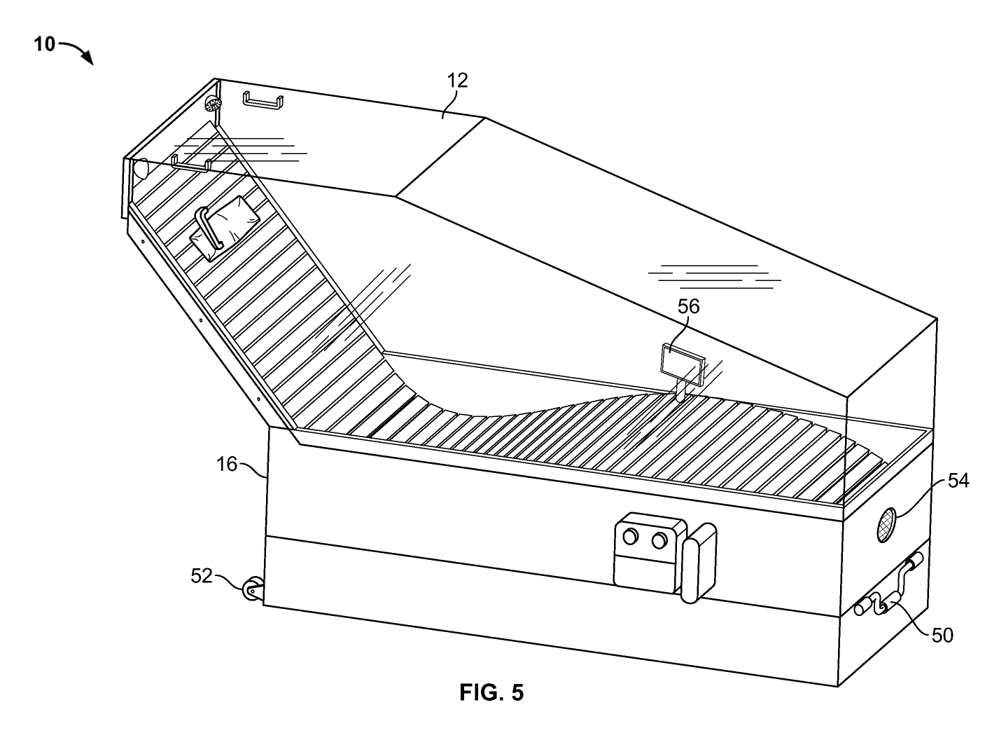

As depicted in the embodiment of FIG. 4, a bottom drain matt and vapor barrier 36 may be a water proof material or membrane is located between the ground and the rest of the device 10. The barrier 36 is used for a moister barrier; it helps from keeping the ground from getting wet. The material also extends out from the side where the human enters or exits the device 10, so any sweat will not drop on the ground. Speakers 38 may be one or more built-in speakers for an external music player or internal music player. A music player may be provided in the kiosk electronics. An electric fan with filter 40 may suck in and circulate air from the outside to evaporate the device 10 and let more breathable oxygen when using the device 10. A kiosk 56 may include controls for the steam generator, heater, timer, fan, and music, and may have a display that includes the time, a timer, and the temperature.

FIG. 5 depicts an embodiment of a device 10 with a transportation handle 50 and transportation wheels 52. Also included is a fan filter vent 54.

An embodiment may include a storage cover made from canvas or vinyl material. The storage cover slips over the device to keep the device from getting dirty, away from weathering or wetness. Embodiments may include a vibrating plate, vibrating at a certain frequency can result in higher bone density and weight loss, or a water resistant massage pad that vibrates and massages muscles.

In an embodiment, the base is may be framed with a veneer on the outside. The frame supports the contour chair, back rest, cover and all the components. The cover may be opened up by pushing the handle forward and upward to open the device. The human user climbs in the device and sits down on a contour slightly laid back lounge chair. The user pulls down and back on the inside handle to close the cover over the user. The user selects whether to turn on the steam room, heaters, music or fan from the kiosk. Steam room controls are hi/low for temperature change and/or timer for controlling how long the steam in on for. Electric heater controls are hi/low for temperature change and/or timer for controlling how long the heater in on for. Infrared heater controls are hi/low for temperature change and/or timer for controlling how long the heater in on for. Fan controls are on/off with multi-speed. Music controls volume, change songs, stop, pause, play, and shuffle. After a session, the user turns off the device or device will turn off by itself, and then the user pushes the handle forward and upward. The hydraulic will help lift the cover. The user climbs out of the device and showers off.

I claim:

1. A device for delivering a therapy to a user, comprising:
a reclining surface for the user;
a source that produces therapy; and
an enclosure adapted to enclose the reclining surface and the user;
wherein the enclosure transitions between an open position, where the reclining surface is exposed for access by the user, and a closed position, where the reclining surface and the user are enclosed by the enclosure and the enclosure partially retains the therapy, thereby delivering the therapy to the user.

2. The device of claim 1, wherein the therapy is water vapor, and the source that produces therapy is a water vapor generator.

3. The device of claim 1, wherein the therapy is steam, and the source that produces therapy is a steam generator.

4. The device of claim 1, wherein the therapy is heat, and the source that produces therapy is an infrared heater.

5. The device of claim 1, wherein the therapy is heat, and the source that produces therapy is an electric heater.

6. The device of claim 1, further comprising:
a tray to hold aromatic oil;
wherein the source that produces therapy warms the oil so as to evaporate the oil, and the enclosure partially retains the evaporated oil.

7. The device of claim 1, wherein the source that produces therapy is positioned relative to the reclining surface so that the therapy rises through the reclining surface to the user.

8. The device of claim 1, wherein the enclosure completely surrounds the user.

9. The device of claim 1, wherein the enclosure is made of a clear, rigid material.

10. The device of claim 1, further comprising:
a handle to assist in transitioning the enclosure between the closed position and open position.

10. The device of claim 1, further comprising:
a hydraulic arm to assist in transitioning the enclosure between the closed position and open position.

12. The device of claim 1, wherein the enclosure slides forward and tilts upward to allow the user to get in and out of the device.

13. The device of claim 1, wherein the enclosure tilts to the side to allow the user to get in and out of the device.

14. The device of claim 1, further comprising:
speakers for music.

15. The device of claim 1, further comprising:
a kiosk, accessible to the user from inside the device, including controls for controlling the source that produces therapy.

16. The device of claim 1, further comprising:
a fan to circulate air from outside the device.

17. The device of claim 1, further comprising:
transportation wheels.

18. A personal sauna, comprising:
a lounge chair;
a therapy generator; and
an enclosure that keeps in the therapy;
wherein the enclosure opens for access, and closes to enclosure the chair.

19. The sauna of claim 18, wherein the therapy is selected from the group consisting of:
water vapor, steam, heat, and aromatic oil.

20. A method of delivering a therapy to a user, comprising:
reclining the user on a reclining surface;
enclosing the user and the reclining surface with a clear enclosure; and
generating a therapy, selected from the group consisting of water vapor, steam, heat, and aromatic oil;
wherein the enclosure partially retains the therapy, thereby delivering the therapy to the user.
